(19) United States
(12) Patent Application Publication
(10) Pub. No.: US 2010/0213190 A1
(43) Pub. Date: Aug. 26, 2010

(54) FLOW-THROUGH INDUCTION HEATER

(75) Inventors: Andries Bron, Drachten (NL); Klaas Kooijker, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/682,275

(22) PCT Filed: Oct. 13, 2008
(86) PCT No.: PCT/IB2008/054193

§ 371 Date: Apr. 9, 2010

(30) Foreign Application Priority Data
Oct. 18, 2007 (EP) 07118751.2

(51) Int. Cl. H05B 6/10

(52) U.S. Cl. 219/629

(57) ABSTRACT

A flow-through heater (1) provided with a channel (2) for guiding a liquid to be heated. The flow-through heater (1) comprises a ferromagnetic wall (5) encasing an induction coil (4) for heating at least a wall portion of the ferromagnetic wall (5), wherein the channel (2) extends along said wall portion. In this construction, no additional electromagnetic shield is required.

### FIELD OF THE INVENTION

The invention relates to a flow-through heater based on induction heating, particularly for heating water.

### BACKGROUND OF THE INVENTION

Induction heating is the process of heating a metal object by electromagnetic induction, where an electromagnetic flux generates eddy currents within the metal and resistance leads to heating of the metal. The heated metal can be used as a heating element for heating a substance, e.g., in flow-through induction heaters. In flow-through induction heaters water is heated by an induction coil surrounding a ferro-magnetic section of a water supply line. A high frequency magnetic flux in the coil generates heat in the ferro-magnetic section which in turn heats the water. Since the heat is generated in the ferromagnetic material, there is no energy loss due to thermal barriers. The contact-free way of heat transfer allows the use of thin walls and fast heating. Induction heaters can be controlled very effectively and directly. An induction heater in a water-supply device is for instance disclosed in JP 09-075219.

For safety reasons such an induction coil must be shielded with an electromagnetic field shield, typically made of a ferromagnetic material such as ferrite. Such a shield performs no other function than protecting the environment against the impact of the electromagnetic flux. In such a construction, only part of the magnetic flux is used to generate heat for heating the water.

The object of the invention is to provide a flow-through induction heater construction with improved heating efficiency.

### BRIEF DESCRIPTION OF THE INVENTION

The object of the invention is achieved with a flow-through heater provided with a channel for guiding a liquid to be heated, and comprising a ferromagnetic wall encasing an induction coil for heating at least a wall portion of the ferromagnetic wall, wherein the channel extends along said wall portion.

This way, the induction coil is shielded by the ferromagnetic channel wall and no separate electromagnetic shield is needed. No heat is lost via an electromagnetic shield and highly efficient heat transfer to liquid is achieved. While so far induction coils are typically used for inducing eddy currents to heat objects placed in the interior of the coil, it has now been found that also a ferromagnetic heater wall along the exterior of the coil can be heated in a surprisingly effective manner.

In a specific embodiment, the ferromagnetic wall is the outer wall of a double walled casing, e.g., a double walled cylinder, with an inner wall disposed at the interior of the induction coil, in such way that the induction coil is disposed between the ferromagnetic wall and the inner wall. Optionally, the channel extends also along at least a portion of the inner surface of the inner wall, so that the water to be heated flows along the outer wall as well as the inner wall of the double walled casing to further optimize heating efficiency.

Alternatively, the ferromagnetic wall is formed by a casing, e.g., a cylinder, which has at least one closed end and which casing encases the induction coil, the casing being surrounded by a second wall, wherein the channel runs between the ferromagnetic wall and the second wall and wherein the channel is operatively connected to a supply line and a discharge line. The casing can for example be closed by a circular end wall. The surrounding second wall can, e.g., a coaxial cylindrical wall. This way, the heater can be configured to guide the water flow along the ferromagnetic wall, while the space enclosed by the coil is blocked from the flow path. This allows a simpler and cheaper construction of the heater.

To further optimize heat transfer, the wall surrounding the induction coil can for example be provided with one or more partitions to define a flow path along the ferromagnetic wall, for instance by defining a spiral or helical flow path. In case the ferromagnetic wall is a body with a longitudinal axis, or forms part of such a longitudinal body, the partitions may extend radially relative to the longitudinal axis. The partitions can for example be radially extending partitions on a cylindrical ferromagnetic wall.

The induction coil is usually made of 3 mm-5 mm diameter copper tubing. Diameter, shape, and number of turns can be selected to influence the desired efficiency and field pattern.

The ferromagnetic material of the outer surface of a casing shielding the induction coil can be any suitable steel type generally used in the field of water supply lines.

A high frequency electric power supply means can be used to supply high frequency AC power to the induction coil. The frequency of the alternating current can, e.g., be 50-400 KHz, for instance 100-300 KHz.

Optionally, the supplied high frequency electric power can be adjusted in accordance with a preset temperature, e.g. using a thermostat.

The heater according to the present invention is suitable for use in commercial, domestic and industrial environments.

### BRIEF DESCRIPTION OF THE DRAWINGS

FIG. 1A in cross section a heater according to the present invention;

FIG. 1B the heater of FIG. 1A in perspective cross section;

FIG. 2 second embodiment of a heater according to the invention in perspective cross section;

FIG. 3 third embodiment of a heater according to the invention in perspective cross section;

FIG. 4 fourth embodiment of a heater according to the invention.

### DETAILED DESCRIPTION OF THE EMBODIMENTS

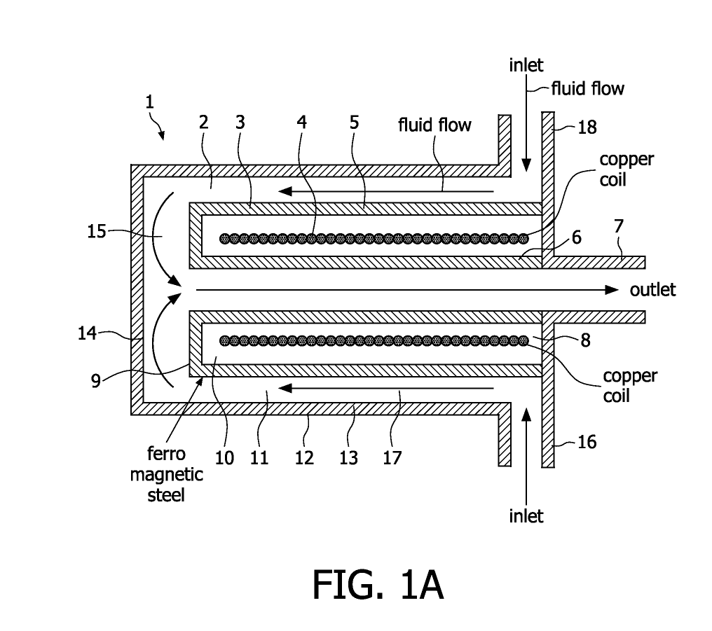

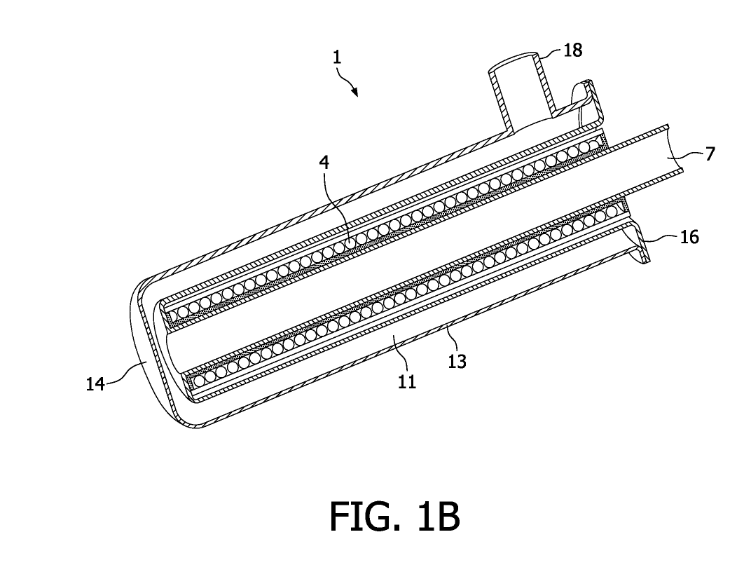

FIG. 1A shows in cross section a flow-through heater 1. This cross section is shown in perspective in FIG. 1B. The flow-through heater 1 comprises a channel 2 for guiding liquid to be heated, in particular water. A double walled cylinder 3 encases an induction coil 4. The double walled cylinder 3 comprises an outer cylinder 5 of a ferromagnetic metal surrounding the induction coil 4, and an inner pipe line 6 surrounded by the induction coil 4. The inner pipe line 6 is in open connection and in line with a discharge line 7. Two annular end walls 8, 9 close off the space 10 between the outer and inner walls 5, 6. The outer cylinder wall 5 surrounding the induction coil 4 forms an inner wall of an annular section 11 of the flow path channel 2. The outer wall of the annular channel section 11 is formed by a casing 12 comprising a cylindrical wall 13 capped by a circular end wall 14. The cylindrical wall 13 stands proud of the double walled cylinder 3 encasing the induction coil 4, resulting in a space 15 between the circular end wall 14 on the one end and the annular end wall 9 of the double walled cylinder 3 on the other hand. At the other end, an annular end wall 16 closes off an annular space 17 between the double walled cylinder 3 and the cylindrical casing wall 13. Near the annular end wall 16, a supply line 18 is joined to the cylindrical casing wall to form an open connection with the annular space 17 between the double walled cylinder 3 and the cylindrical casing wall 13.

The flow path for water to be heated is indicated in the drawings by the arrows. Water flows from the supply line 18 via the annular channel formed by the annular space 17 between the double walled cylinder 3 and the cylindrical casing wall 13, and further via the space 15 between the circular end wall 14 and the annular end wall 9 of the double walled cylinder 3 into the inner pipe line 6 of the double walled cylinder 3 and further into the discharge line 7.

At the inner side of the induction coil 4, the generated magnetic flux heats the inner pipeline 6, thus heating passing water. At the outer side of the coil 4, the flux is shielded by the wall 5. Heat is generated in the wall 5 which is absorbed by the water passing the flow path.

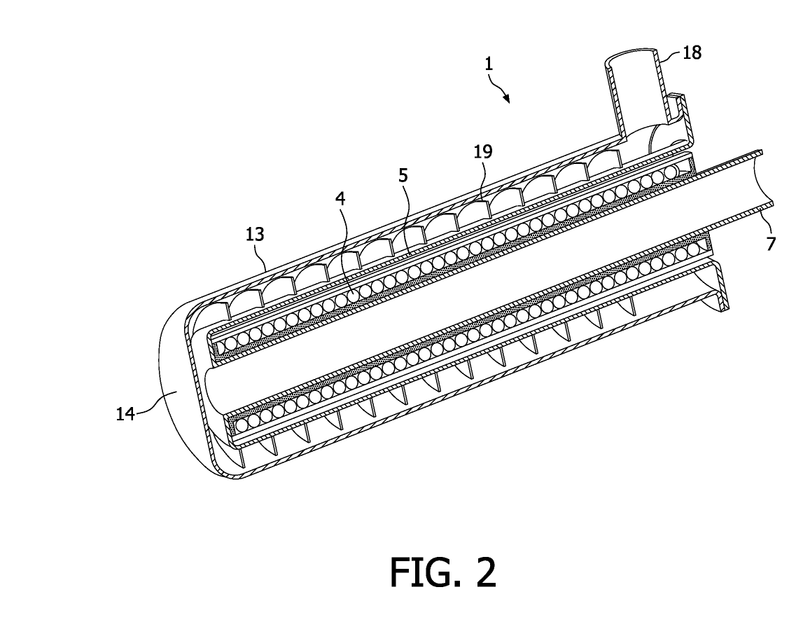

FIG. 2 shows in perspective a cross section of a second embodiment of the heater 1 according to the invention. The heater 1 has a similar construction as the heater shown in FIGS. 1A and 1B. Parts common to both embodiments will be referred to by identical reference numerals. The embodiment of FIG. 2 differs with the embodiment of FIGS. 1A and B in that the outer surface 5 of the double walled cylinder 3 is provided with a radially extending spiral partition 19. The spiral partition 19 defines a spiral flow path, serving to maximize heat transfer from the shield 5 to passing water.

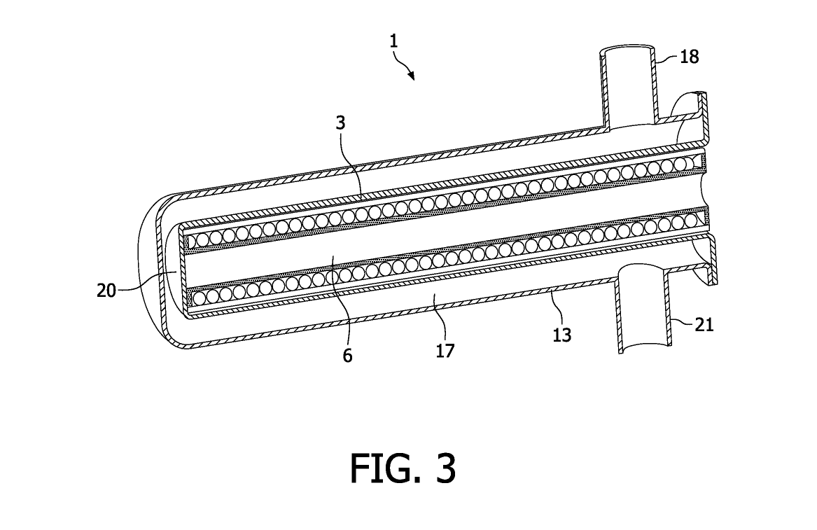

FIG. 3 shows a further embodiment of the heater 1 according to the invention. Again, parts common to both embodiments are referred to by identical reference numerals. In contrast to the embodiment of FIGS. 1A and 1B and the embodiment of FIG. 2 a double walled cylinder 3 is capped with a circular end wall 20 closing off the inner pipe line 6. A discharge line 21 is joined to a cylindrical casing wall 13 opposite a supply line 18. Water flows from the supply line 18 to the discharge line 21 via an annular space 17 between the double walled cylinder 3 and the inner surface of the cylindrical casing wall 13.

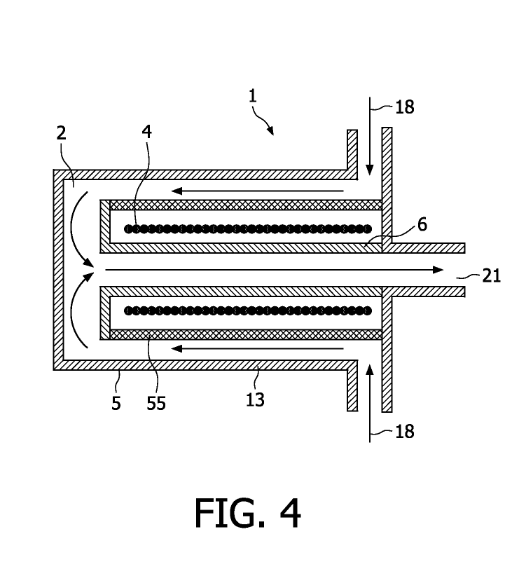

FIG. 4 shows a further embodiment of the heater 1 according to the invention. The heater 1 has a channel 2. Fluid to be heated enters the channel via a supply line 18 and exits the channel via a discharge line 21. The fluid is guided by a second wall 13 and a coil encasing wall 55 around an induction coil 4. Before flowing through the discharge line 21 the fluid is guided through an inner pipeline 6. The inner pipe line 6 is surrounded by the induction coil 4. The second wall 13 has a ferromagnetic wall 5. The coil encasing wall 55 may comprise ferromagnetic material, but this is not necessary as will be explained hereafter. Ferromagnetic wall 5 serves as a shield protecting the environment against the impact of the electromagnetic flux. At the same time a part of the magnetic flux produced by the induction coil 4 may produce eddy currents in portions of the ferromagnetic wall 5 which portions comprise ferromagnetic material. In this embodiment the ferromagnetic wall 5 combines the electromagnetic shielding function with the possibility of heating the fluid which flows through the channel 2 of heater 1.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. Devices, elements and components, known per se, have not been described in detail, as the skilled person is familiar with the matter. In the claims, the word “comprising” does not exclude other elements or steps, and the indefinite article “a” or “an” does not exclude a plurality. A single mechanism or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. A flow-through heater (1) provided with a channel (2) for guiding a liquid to be heated, and comprising a ferromagnetic wall (5) encasing an induction coil (4) for heating at least a wall portion of the ferromagnetic wall (5), wherein the channel (2) extends along said wall portion.

2. Flow-through heater according to claim 1 wherein the ferromagnetic wall (5) is the outer wall of a double walled casing (3) with an inner wall (6) of a ferromagnetic material, the induction coil being disposed between the ferromagnetic wall (5) and the inner wall (6), and wherein the channel (2) extends along at least a portion of the inner surface of the inner wall (6).

3. Flow-through heater according to claim 1 wherein the ferromagnetic wall (5) is formed by a casing (3) having at least one closed end (20) and encasing the induction coil (4), the casing (3) being surrounded by a second wall (13), and wherein the channel (2) runs between the ferromagnetic wall (5) and the second wall (13) and wherein the channel (2) is operatively connected to a supply line (18) and a discharge line (21).

4. Flow-through heater according to claim 1 characterized in that the ferromagnetic wall (5) is a cylindrical wall (3).

5. Flow-through heater according to claim 1 wherein the ferromagnetic wall (5) is provided with one or more partitions (19) defining a flow path.

6. Flow-through heater according to claim 5 wherein the partitions (19) define a spiral flow path.
